(19) United States
(12) Patent Application Publication
(10) Pub. No.: US 2025/0280330 A1
(43) Pub. Date: Sep. 4, 2025

(54) APPARATUS, SYSTEM, AND METHOD OF DYNAMIC BANDWIDTH FOR WIRELESS COMMUNICATION

(71) Applicant: INTEL CORPORATION, Santa Clara, CA (US)

(72) Inventor: Laurent Cariou, Milizac (FR)

(73) Assignee: INTEL CORPORATION, Santa Clara, CA (US)

(21) Appl. No.: 19/191,774

(22) Filed: Apr. 28, 2025

Related U.S. Application Data
(60) Provisional application No. 63/641,333, filed on May 1, 2024.

(51) Int. Cl. H04W 28/20; H04W 72/0453

(52) U.S. Cl. CPC H04W 28/20; H04W 72/0453

(57) ABSTRACT

For example, an Access Point (AP) may be configured to set a frequency-resource field in a Dynamic Bandwidth Expansion (DBE) announcement frame, the DBE announcement frame to announce a dynamic Basic Service Set (BSS) Bandwidth (BW) change from a first dynamic BSS BW to a second dynamic BSS BW different from the first dynamic BSS BW. For example, the frequency-resource field may be configured to indicate an announced frequency resource within the second dynamic BSS BW for communication between the AP and at least one non-AP station (STA). For example, the AP may be configured to transmit the DBE announcement frame including the frequency-resource field. For example, a non-AP STA may be configured to process the frequency-resource field in the DBE announcement frame, and to communicate with the AP based on the announced frequency resource within the second dynamic BSS BW.

### CROSS REFERENCE

This Application claims the benefit of and priority from U.S. Provisional Patent Application No. 63/641,333 entitled “DYNAMIC ULTRA HIGH RELIABILITY (UHR) BASIC SERVICE SET (BSS) BANDWIDTH WITH DYNAMIC SUBBAND OPERATION (DSO) AND NON-PRIMARY CHANNEL ACCESS (NPCA)”, filed May 1, 2024, the entire disclosure of which is incorporated herein by reference.

### BACKGROUND

Devices in a wireless communication system may be configured to communicate over a channel Bandwidth (BW), e.g., a channel BW of 40 Megahertz (MHz), 80 MHz, or the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic flow-chart illustration of a method of dynamic bandwidth, in accordance with some demonstrative aspects.

FIG. 3 is a schematic flow-chart illustration of a method of dynamic bandwidth, in accordance with some demonstrative aspects.

FIG. 4 is a schematic flow-chart illustration of a method of dynamic bandwidth, in accordance with some demonstrative aspects.

FIG. 5 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks-Specific Requirements; Part 11: Wireless LAN Medium Access Control (MAC) and Physical Layer (PHY) Specifications, December 2020); IEEE 802.11be (IEEE P802.11be/D5.0 Draft Standard for Information technology Telecommunications and information exchange between systems Local and metropolitan area networks-Specific requirements; Part 11: Wireless LAN Medium Access Control (MAC) and Physical Layer (PHY) Specifications; Amendment 8: Enhancements for extremely high throughput (EHT), November 2023); and/or IEEE802.11bn (IEEE 802.11bn/D0.2, IEEE Standard for Information Technology-—Telecommunications and Information Exchange between Systems Local and Metropolitan Area Networks-Specific Requirements; Part 11: Wireless LAN Medium Access Control (MAC) and Physical Layer (PHY) Specifications-Amendment: Enhancements for Ultra High Reliability (UHR), March 2025)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6G Hz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mm Wave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHZ, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

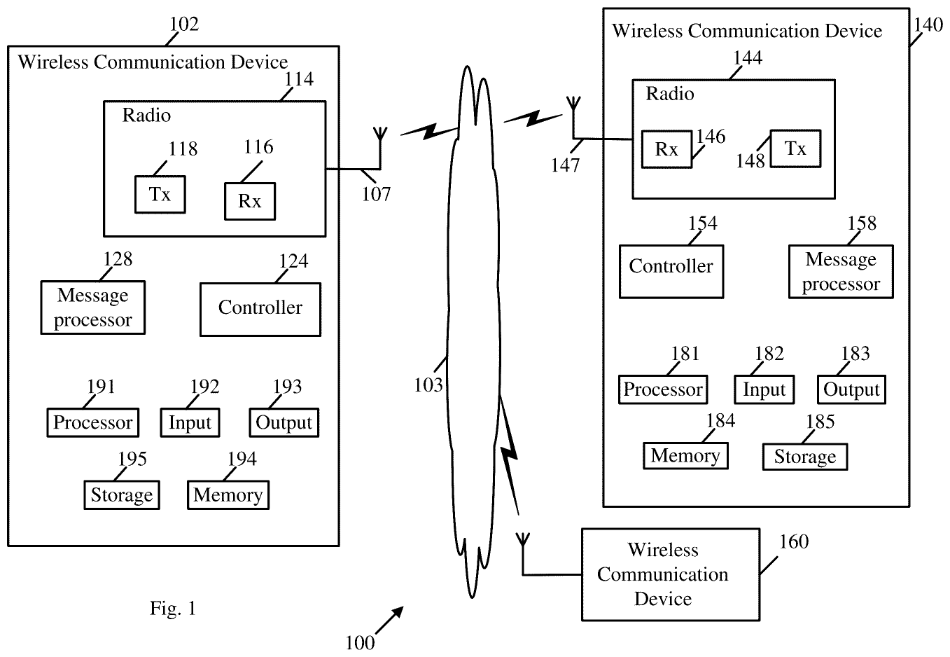

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a Wi-Fi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, an IEEE 802.11be Specification, an IEEE 802.11bn Specification, and/or any other specification and/or protocol.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may include, operate as, perform a role of, and/or perform the functionality of, one or more AP STAs and/or one or more non-AP STAs. In one example, device 102 may include, operate as, perform a role of, and/or perform the functionality of, at least one AP STA, and/or device 140 may include, operate as, perform a role of, and/or perform the functionality of, at least one non-AP STA.

In some demonstrative aspects, device 102 may include, operate as, perform a role of, and/or perform the functionality of, a first STA, e.g., an AP STA or a non-AP STA.

In some demonstrative aspects, device 140 may include, operate as, perform a role of, and/or perform the functionality of, a second STA, e.g., an AP STA or a non-AP STA.

In some demonstrative aspects, device 160 may include, operate as, perform a role of, and/or perform the functionality of, a third STA, e.g., an AP STA or a non-AP STA.

In other aspects, device 102, device 140, and/or device 160 may include, operate as, perform a role of, and/or perform the functionality of any other additional or alternative type of STA.

In some demonstrative aspects, device 102, device 140, and/or device 160 may be configured to communicate one or more PPDUs, for example, in accordance with an IEEE 802.11 Specification.

In some demonstrative aspects, device 102, device 140, and/or device 160 may be configured to generate, transmit, receive, and/or process one or more transmissions of PPDUs, e.g., as described below.

In some demonstrative aspects, device 102, device 140, and/or device 160 may be configured to implement one or more operations and/or functionalities of a dynamic bandwidth mechanism, which may be configured to support communication over a dynamic bandwidth, e.g., as described below.

In some demonstrative aspects, device 102, device 140, and/or device 160 may be configured to implement one or more operations and/or functionalities of a dynamic bandwidth mechanism, which may be configured to support communication over a dynamic bandwidth with Dynamic Sub-band (subband) Operation (DSO), e.g., as described below.

In some demonstrative aspects, device 102, device 140, and/or device 160 may be configured to implement one or more operations and/or functionalities of a dynamic bandwidth mechanism, which may be configured to support communication over a dynamic bandwidth with Non-Primary Channel Access (NPCA), e.g., as described below.

In some demonstrative aspects, device 102, device 140, and/or device 160 may be configured to implement one or more operations and/or functionalities of a dynamic bandwidth mechanism, which may be configured to support communication over a dynamic UHR Basic Service Set (BSS) bandwidth, for example, with DSO and/or NPCA, e.g., as described below.

In some demonstrative aspects, device 102, device 140, and/or device 160 may be configured to implement one or more operations and/or functionalities of a dynamic bandwidth mechanism, which may be configured to provide a technical solution to support dynamic setting, adjustment, configuration, modification, and/or control of a channel BW, for example, a BSS BW, e.g., as descried below.

In some demonstrative aspects, for example, in some use cases, scenarios, and/or deployments, e.g., in enterprise deployments or the like, AP vendors may distribute APs in an area, e.g., in an office area. For example, a frequency reuse pattern may be applied, for example, to provide a technical solution to ensure substantially full coverage, while reducing, or even avoiding, interference between neighboring APs. In such implementations, the bandwidth of the BSS of at least some of the APs, e.g., each AP, may be set to substantially the same BW value, e.g., 40 MHz, 80 MHz, or the like.

For example, the BSS bandwidth values and channel assignments may be fixed for the APs, while the conditions of load can vary quite significantly, for example, day versus night, during meetings, at a gathering of large crowds, or the like.

In some demonstrative aspects, device 102, device 140, and/or device 160 may be configured to implement one or more operations and/or functionalities of a dynamic bandwidth mechanism, which may be configured to provide a technical solution to support dynamically changing the BSS BW, e.g., as described below.

In some demonstrative aspects, the dynamic bandwidth mechanism may be configured to provide a technical solution to address one or more technical aspects, which may not be supported by current protocols, e.g., current versions of the IEEE 802.11 Specifications, e.g., as described below.

For example, a requirement that when an AP performs a BSS bandwidth change, associated STAs, which are associated with the AP, should (re) associate with the AP, may result in one or more technical issues. For example, the reassociation may take time, and may lead to service interruption during that time. For example, in case of a large number of associated STAs, e.g., 100 STAs or 200 STAs, there may be a flood of (re) association request frames, which may be sent to the AP substantially simultaneously, and may create congestion, collisions, and further delays.

In some demonstrative aspects, device 102, device 140, and/or device 160 may be configured to implement one or more operations and/or functionalities of a dynamic bandwidth mechanism, which may be configured to provide a technical solution to support dynamically changing the BSS BW for one or more first STAs (also referred to as “new STAs), e.g., UHR STAs, which support the dynamic bandwidth mechanism, for example, while avoiding an impact on one or more second STAs (also referred to as “legacy STAs”), e.g., non-UHR STAs, which may not support the dynamic bandwidth mechanism, e.g., as described below.

In some demonstrative aspects, device 102, device 140, and/or device 160 may be configured to implement one or more operations and/or functionalities of a dynamic bandwidth mechanism, which may be configured to support one or more operations of a Dynamic Bandwidth Expansion (DBE) mechanism, e.g., as described below.

For example, the DBE mechanism may be configured to provide a technical solution to allow an AP, e.g., a UHR AP, to modify, configure, set, control, and/or adjust an operating BSS bandwidth.

For example, the DBE mechanism may be configured to provide a technical solution to allow the AP, e.g., the UHR AP, to modify, e.g., to expand, reduce, and/or reset, its DBE dynamic bandwidth, for example, for one or more STAs, e.g., UHR STAs that support DBE operation.

For example, the DBE mechanism may be configured to provide a technical solution to define a dynamic BSS BW, which may be allowed to vary between a first BSS BW, e.g., a minimum (MIN) Dynamic BSS BW, and a second BSS BW, e.g., a maximum (MAX) Dynamic BSS BW.

For example, the DBE mechanism may be configured to provide a technical solution to support legacy STAs, e.g., which may be capable of understanding an EHT BW. For example, the dynamic bandwidth mechanism may define that the EHT BW is to be set to the MIN Dynamic BSS BW. For example, the EHT BW may be set to the MIN Dynamic BSS BW, for example, such that the legacy STAs may use the MIN Dynamic BSS BW as their static BSS BW. For example, an AP may advertise a legacy BW, e.g., 80 MHz or the like, to the legacy STAs.

For example, the DBE mechanism may be configured to provide a technical solution to support UHR STAs, which may capable of identifying that there is a Dynamic BSS BW, and setting their BSS BW to the Dynamic BSS BW. For example, the AP may advertise for the UHR STAs a DBE BW, which may allow the UHR STAs to change their BW, e.g., without reassociating with the AP.

For example, the DBE mechanism may be configured to provide a technical solution to support a procedure for the AP to modify the Dynamic BSS BW, e.g., in the range between the MIN Dynamic BSS BW and the MAX Dynamic BSS BW, for example, during BSS lifetime, e.g., without forcing re-association on the STA (client) side.

In some demonstrative aspects, device 102, device 140, and/or device 160 may be configured to implement one or more operations and/or functionalities of a dynamic bandwidth mechanism, which may be configured to provide a technical solution to support coexistence of the DBE mechanism with one or more other BW-related mechanisms, e.g., as described below.

In some demonstrative aspects, device 102, device 140, and/or device 160 may be configured to implement one or more operations and/or functionalities of a dynamic bandwidth mechanism, which may be configured to provide a technical solution to support coexistence of the DBE mechanism with a Dynamic Subband Operation (DSO) mechanism, e.g., as described below.

For example, a DSO non-AP STA may include a non-AP STA, which supports the DSO. For example, the non-AP STA may set to 1 a DSO supported filed in a capabilities information field of a UHR capabilities element transmitted by the non-AP STA, for example, to indicate that the non-AP STA is a DSO non-AP STA.

For example, a DSO AP may include an AP, which supports the DSO. For example, the AP may set to 1 a DSO supported filed in a capabilities information field of a UHR capabilities element transmitted by the AP, for example, to indicate that the AP is a DSO AP.

For example, the DSO mechanism may be configured to provide a technical solution where a DSO non-AP STA that has an operating bandwidth narrower than a DSO AP can dynamically be allocated frequency resources outside of its current operating bandwidth, for example, within the DSO AP's BSS bandwidth, e.g., on a per Transmit Opportunity (TXOP) basis, e.g., in accordance with an IEEE 802.11bn Specification.

In some demonstrative aspects, device 102, device 140, and/or device 160 may be configured to implement one or more operations and/or functionalities of a dynamic bandwidth mechanism, which may be configured to provide a technical solution to support coexistence of the DBE mechanism with a Non-Primary Channel Access (NPCA) mechanism, e.g., as described below.

For example, an NPCA non-AP STA may include a non-AP STA, which supports the NPCA. For example, the non-AP STA may set to 1 an NPCA supported filed in a capabilities information field of a UHR capabilities element transmitted by the non-AP STA, for example, to indicate that the non-AP STA is an NPCA non-AP STA.

For example, an NPCA AP may include an AP, which supports the NPCA. For example, the AP may set to 1 an NPCA supported filed in a capabilities information field of a UHR capabilities element transmitted by the AP, for example, to indicate that the AP is an NPCA AP.

For example, the NPCA mechanism may be configured to provide a technical solution where an NPCA AP may request an NPCA non-AP STA to switch to an NPCA primary channel for NPCA operation, e.g., in accordance with an IEEE 802.11bn Specification.

In some demonstrative aspects, device 102, device 140, and/or device 160 may be configured to implement one or more operations and/or functionalities of a dynamic bandwidth mechanism, which may be configured to provide a technical solution to support an AP in updating one or more parameters of one or more BW-related mechanisms, e.g., the DSO mechanism, the NPCA mechanism and/or any other mechanism, for example, according to a dynamic bandwidth modification, e.g., according to a DBE operation, to be performed by the AP, e.g., as described below.

In some demonstrative aspects, device 102, device 140, and/or device 160 may be configured to implement one or more operations and/or functionalities of a dynamic bandwidth mechanism, which may be configured to provide a technical solution to support an AP in signaling, announcing, advertising, and/or indicating one or more parameters of one or more BW-related mechanisms, e.g., the DSO mechanism, the NPCA mechanism and/or any other mechanism, for example, according to a dynamic bandwidth modification, e.g., according to a DBE operation, to be performed by the AP, e.g., as described below.

In some demonstrative aspects, device 102, device 140, and/or device 160 may be configured to implement one or more operations and/or functionalities of a dynamic bandwidth mechanism, which may be configured to provide a technical solution to support an AP in negotiating one or more parameters of one or more BW-related mechanisms, e.g., the DSO mechanism, the NPCA mechanism and/or any other mechanism, for example, according to a dynamic bandwidth modification, e.g., according to a DBE operation, to be performed by the AP, e.g., as described below.

Some demonstrative aspects are described herein with respect to a dynamic bandwidth mechanism utilizing one or more operations, communications, and/or frames, which may be configured according to a DBE mechanism. In other aspects, the dynamic bandwidth mechanism may be configured to utilize any other suitable type of operations, communications, and/or frames, e.g., according to any other dynamic bandwidth operation.

In some demonstrative aspects, controller 124 may be configured to control, trigger, cause, and/or instruct an AP implemented by device 102 to set a frequency-resource field in a DBE announcement frame, e.g., as described below.

In some demonstrative aspects, the DBE announcement frame may be configured to announce a dynamic Basic Service Set (BSS) Bandwidth (BW) change from a first dynamic BSS BW to a second dynamic BSS BW different from the first dynamic BSS BW, e.g., as described below.

In some demonstrative aspects, the frequency-resource field may be configured to indicate an announced frequency resource within the second dynamic BSS BW for communication between the AP and at least one non-AP STA, e.g., as described below.

In some demonstrative aspects, controller 124 may be configured to control, trigger, cause, and/or instruct the AP implemented by device 102 to transmit the DBE announcement frame, e.g., as described below.

In some demonstrative aspects, the AP implemented by device 102 may include a UHR AP, e.g., as described below. In other aspects, the AP implemented by device 102 may include any other additional or alternative type of AP.

In some demonstrative aspects, the DBE announcement frame may be configured to announce a dynamic BSS BW expansion from the first dynamic BSS BW to the second dynamic BSS BW. For example, the second dynamic BSS BW may be wider than the first dynamic BSS BW, e.g., as described below.

In some demonstrative aspects, the DBE announcement frame may be configured to announce a dynamic BSS BW reduction from the first dynamic BSS BW to the second dynamic BSS BW. For example, the second dynamic BSS BW may be narrower than the first dynamic BSS BW, e.g., as described below.

In some demonstrative aspects, the announced frequency resource, which is indicated by the frequency-resource field in the DBE announcement frame, may be different from a current frequency resource within the first dynamic BSS for communication between the AP and the non-AP STA, e.g., as described below.

In some demonstrative aspects, the announced frequency resource, which is indicated by the frequency-resource field in the DBE announcement frame, may be outside the first dynamic BSS BW, e.g., as described below.

In some demonstrative aspects, the announced frequency resource, which is indicated by the frequency-resource field in the DBE announcement frame, may be within the first dynamic BSS BW, e.g., as described below.

In some demonstrative aspects, the frequency-resource field in the DBE announcement frame may be configured to indicate an announced DSO sub-band within the second dynamic BSS BW for a DSO STA functionality of the non-AP STA, e.g., as described below.

In some demonstrative aspects, the announced DSO sub-band may be outside an operating BW of the DSO STA, e.g., as described below.

In some demonstrative aspects, the announced DSO sub-band within the second dynamic BSS BW may be different from a current DSO sub-band within the first dynamic BSS BW, e.g., as described below.

In some demonstrative aspects, controller 124 may be configured to control, trigger, cause, and/or instruct the AP implemented by device 102 to wait for expiration of a time period., for example, after transmission of the DBE announcement frame and prior to performing a DSO functionality, e.g., as described below.

In some demonstrative aspects, controller 124 may be configured to control, trigger, cause, and/or instruct the AP implemented by device 102 to determine the time period, for example, based on capability information from the non-AP STA, e.g., as described below.

In some demonstrative aspects, the time period may be predefined, for example according to a standard and/or protocol, e.g., as described below.

In some demonstrative aspects, controller 124 may be configured to control, trigger, cause, and/or instruct the AP implemented by device 102 to determine the announced DSO sub-band within the second dynamic BSS BW, for example, based on a DSO re-negotiation with the non-AP STA, e.g., as described below.

In some demonstrative aspects, controller 124 may be configured to control, trigger, cause, and/or instruct the AP implemented by device 102 to determine the announced DSO sub-band within the second dynamic BSS BW to be the same as a current DSO sub-band within the first dynamic BSS BW, for example, when, e.g., based on a determination that, the current DSO sub-band is within the second dynamic BSS BW, e.g., as described below.

In some demonstrative aspects, controller 124 may be configured to control, trigger, cause, and/or instruct the AP implemented by device 102 to determine that the announced DSO sub-band within the second dynamic BSS BW is to include a particular channel in the second dynamic BSS BW, for example, when, e.g., based on a determination that, there is no other possible sub-band for DSO in the second dynamic BSS BW, e.g., as described below.

In some demonstrative aspects, controller 124 may be configured to control, trigger, cause, and/or instruct the AP implemented by device 102 to wait for expiration of a time period after transmission of the DBE announcement frame and prior to performing a DSO functionality over the particular channel, e.g., as described below.

In some demonstrative aspects, controller 124 may be configured to control, trigger, cause, and/or instruct the AP implemented by device 102 to determine the time period, for example, based on capability information from the non-AP STA, e.g., as described below.

In some demonstrative aspects, the time period may be predefined, e.g., according to standard and/or protocol, e.g., as described below.

In some demonstrative aspects, controller 124 may be configured to control, trigger, cause, and/or instruct the AP implemented by device 102 to set an enablement field in the DBE announcement frame, for example, to indicate whether DSO is to be enabled or disabled in the second dynamic BSS BW, e.g., as described below.

In some demonstrative aspects, controller 124 may be configured to control, trigger, cause, and/or instruct the AP implemented by device 102 to set the frequency-resource field in the DBE announcement frame, for example, to indicate a particular DSO sub-band for a particular non-AP STA, e.g., as described below.

In some demonstrative aspects, controller 124 may be configured to control, trigger, cause, and/or instruct the AP implemented by device 102 to transmit the DBE announcement frame as a unicast frame addressed to the particular non-AP STA, e.g., as described below.

In some demonstrative aspects, controller 124 may be configured to control, trigger, cause, and/or instruct the AP implemented by device 102 to transmit the DBE announcement frame as a broadcast frame, e.g., as described below.

In some demonstrative aspects, controller 124 may be configured to control, trigger, cause, and/or instruct the AP implemented by device 102 to set the frequency-resource field in the DBE announcement frame, for example, to indicate a plurality of candidate DSO sub-bands in the second dynamic BSS BW, e.g., as described below.

In some demonstrative aspects, controller 124 may be configured to control, trigger, cause, and/or instruct the AP implemented by device 102 to set the frequency-resource field in the DBE announcement frame, for example, to indicate an allocation of a plurality of DSO sub-bands in the second dynamic BSS BW to a plurality of non-AP STAs, e.g., as described below.

In some demonstrative aspects, controller 124 may be configured to control, trigger, cause, and/or instruct the AP implemented by device 102 to set the frequency-resource field in the DBE announcement frame, for example, to indicate an allocation of a same DSO sub-band in the second dynamic BSS BW to a plurality of non-AP STAs, e.g., as described below.

In some demonstrative aspects, the frequency-resource field in the DBE announcement frame may be configured to indicate an announced NPCA primary channel within the second dynamic BSS BW, e.g., as described below.

In some demonstrative aspects, the announced NPCA primary channel may be configured for NPCA operation over a non-primary channel in the second dynamic BSS BW, e.g., as described below.

In some demonstrative aspects, the announced NPCA primary channel within the second dynamic BSS BW may be different from a current NPCA primary channel within the first dynamic BSS BW, e.g., as described below.

In some demonstrative aspects, controller 124 may be configured to control, trigger, cause, and/or instruct the AP implemented by device 102 to set an enablement field in the DBE announcement frame, for example, to indicate whether NPCA is to be enabled or disabled in the second dynamic BSS BW, e.g., as described below.

In some demonstrative aspects, controller 124 may be configured to control, trigger, cause, and/or instruct cause all APs affiliated with a same AP Multi Link Device (MLD) implemented by device 102 to transmit DBE announcement frames including the frequency-resource field, for example, to indicate the announced frequency resource with the announcement of the dynamic BSS BW change from the first dynamic BSS BW to the second dynamic BSS BW, e.g., as described below.

In some demonstrative aspects, controller 154 may be configured to control, trigger, cause, and/or instruct a non-AP STA implemented by device 140 to process a DBE announcement frame from an AP, for example, to identify an announced dynamic BSS BW change from a first dynamic BSS BW to a second dynamic BSS BW different from the first dynamic BSS BW, e.g., as described below.

In some demonstrative aspects, controller 154 may be configured to control, trigger, cause, and/or instruct the non-AP STA implemented by device 140 to process a frequency-resource field in the DBE announcement frame, for example, to identify an announced frequency resource within the second dynamic BSS BW, e.g., as described below.

For example, the DBE announcement frame received by the non-AP STA implemented by device 140 may include the DBE announcement frame transmitted by the AP implemented by device 102, e.g., as described above.

In some demonstrative aspects, controller 154 may be configured to control, trigger, cause, and/or instruct the non-AP STA implemented by device 140 to communicate with the AP based on the announced frequency resource within the second dynamic BSS BW, e.g., as described below.

In some demonstrative aspects, the non-AP STA implemented by device 140 may include a UHR non-AP STA, e.g., as described below. In other aspects, the non-AP STA implemented by device 102 may include any other additional or alternative type of non-AP STA.

In some demonstrative aspects, the DBE announcement frame may be configured to announce a dynamic BSS BW expansion from the first dynamic BSS BW to the second dynamic BSS BW. For example, the second dynamic BSS BW may be wider than the first dynamic BSS BW, e.g., as described below.

In some demonstrative aspects, the DBE announcement frame may be configured to announce a dynamic BSS BW reduction from the first dynamic BSS BW to the second dynamic BSS BW. For example, the second dynamic BSS BW may be narrower than the first dynamic BSS BW, e.g., as described below.

In some demonstrative aspects, the announced frequency resource, which is indicated by the frequency-resource field in the DBE announcement frame, may be different from a current frequency resource within the first dynamic BSS for communication between the AP and the non-AP STA, e.g., as described below.

In some demonstrative aspects, the announced frequency resource, which is indicated by the frequency-resource field in the DBE announcement frame, may be outside the first dynamic BSS BW, e.g., as described below.

In some demonstrative aspects, the announced frequency resource, which is indicated by the frequency-resource field in the DBE announcement frame, may be within the first dynamic BSS BW, e.g., as described below.

In some demonstrative aspects, controller 154 may be configured to control, trigger, cause, and/or instruct the non-AP STA implemented by device 140 to process the frequency-resource field in the DBE announcement frame, for example, to identify that the frequency-resource field is configured to indicate an announced DSO sub-band within the second dynamic BSS BW for a DSO STA functionality of the non-AP STA. For example, the announced DSO sub-band may be outside an operating BW of the DSO STA, e.g., as described below.

In some demonstrative aspects, the announced DSO sub-band within the second dynamic BSS BW may be different from a current DSO sub-band within the first dynamic BSS BW, e.g., as described below.

In some demonstrative aspects, controller 154 may be configured to control, trigger, cause, and/or instruct the non-AP STA implemented by device 140 to negotiate the announced DSO sub-band within the second dynamic BSS BW, for example, based on a DSO re-negotiation with the AP, e.g., as described below.

In some demonstrative aspects, controller 154 may be configured to control, trigger, cause, and/or instruct the non-AP STA implemented by device 140 to transmit to the AP capability information, for example, to indicate a time period that the AP is to wait before performing a DSO functionality following transmission of the DBE announcement frame, e.g., as described below.

In some demonstrative aspects, controller 154 may be configured to control, trigger, cause, and/or instruct the non-AP STA implemented by device 140 to identify the announced DSO sub-band within the second dynamic BSS BW to be the same as a current DSO sub-band within the first dynamic BSS BW, for example, when, e.g., based on a determination that, the current DSO sub-band is within the second dynamic BSS BW, e.g., as described below.

In some demonstrative aspects, controller 154 may be configured to control, trigger, cause, and/or instruct the non-AP STA implemented by device 140 to determine that the announced DSO sub-band within the second dynamic BSS BW is to include a particular channel in the second dynamic BSS BW, for example, when, e.g., based on a determination that, there is no other possible sub-band for DSO in the second dynamic BSS BW, e.g., as described below.

In some demonstrative aspects, controller 154 may be configured to control, trigger, cause, and/or instruct the non-AP STA implemented by device 140 to transmit to the AP capability information, for example, to indicate a time period that the AP is to wait before performing a DSO functionality over the particular channel following transmission of the DBE announcement frame, e.g., as described below.

In some demonstrative aspects, controller 154 may be configured to control, trigger, cause, and/or instruct the non-AP STA implemented by device 140 to process an enablement field in the DBE announcement frame, for example, to identify whether DSO is to be enabled or disabled in the second dynamic BSS BW, e.g., as described below.

In some demonstrative aspects, controller 154 may be configured to disable DSO in the second dynamic BSS BW for the non-AP STA implemented by device 140, for example, based on a determination that the enablement field in the DBE announcement frame is to indicate that DSO is to be disabled in the second dynamic BSS BW.

In some demonstrative aspects, controller 154 may be configured to enable DSO in the second dynamic BSS BW for the non-AP STA implemented by device 140, for example, based on a determination that the enablement field in the DBE announcement frame is to indicate that DSO is to be enabled in the second dynamic BSS BW.

In some demonstrative aspects, controller 154 may be configured to control, trigger, cause, and/or instruct the non-AP STA implemented by device 140 to identify that the DBE announcement frame is a unicast frame addressed to the particular non-AP STA, and to process the frequency-resource field, for example, to identify a particular DSO sub-band for the non-AP STA, e.g., as described below.

In some demonstrative aspects, controller 154 may be configured to control, trigger, cause, and/or instruct the non-AP STA implemented by device 140 to identify that the DBE announcement frame is a broadcast frame, and to process the frequency-resource field, for example, to identify a plurality of candidate DSO sub-bands in the second dynamic BSS BW, e.g., as described below.

In some demonstrative aspects, controller 154 may be configured to control, trigger, cause, and/or instruct the non-AP STA implemented by device 140 to identify that the DBE announcement frame is a broadcast frame, and to process the frequency-resource field, for example, to identify an allocation of a DSO sub-band for the non-AP STA in a plurality of DSO sub-bands in the second dynamic BSS BW allocated to a plurality of non-AP STAs, e.g., as described below.

In some demonstrative aspects, controller 154 may be configured to control, trigger, cause, and/or instruct the non-AP STA implemented by device 140 to identify that the DBE announcement frame is a broadcast frame, and to process the frequency-resource field, for example, to identify an allocation of a same DSO sub-band in the second dynamic BSS BW to a plurality of non-AP STAs comprising the non-AP STA, e.g., as described below.

In some demonstrative aspects, controller 154 may be configured to control, trigger, cause, and/or instruct the non-AP STA implemented by device 140 to process the frequency-resource field in the DBE announcement frame, for example, to identify that the frequency-resource field is configured to indicate an announced NPCA primary channel within the second dynamic BSS BW. For example, the announced NPCA primary channel may be configured for NPCA operation over a non-primary channel in the second dynamic BSS BW, e.g., as described below.

In some demonstrative aspects, the announced NPCA primary channel within the second dynamic BSS BW may be different from a current NPCA primary channel within the first dynamic BSS BW, e.g., as described below.

In some demonstrative aspects, controller 154 may be configured to control, trigger, cause, and/or instruct the non-AP STA implemented by device 140 to process an enablement field in the DBE announcement frame, for example, to identify whether NPCA is to be enabled or disabled in the second dynamic BSS BW, e.g., as described below.

In some demonstrative aspects, controller 154 may be configured to disable NPCA in the second dynamic BSS BW for the non-AP STA implemented by device 140, for example, based on a determination that the enablement field in the DBE announcement frame is to indicate that NPCA is to be disabled in the second dynamic BSS BW.

In some demonstrative aspects, controller 154 may be configured to enable NPCA in the second dynamic BSS BW for the non-AP STA implemented by device 140, for example, based on a determination that the enablement field in the DBE announcement frame is to indicate that NPCA is to be enabled in the second dynamic BSS BW.

In some demonstrative aspects, controller 124 may be configured to control, trigger, cause, and/or instruct an AP implemented by device 102 to identify that at least one DSO STA is associated with the AP over a current DSO sub-band in a first dynamic BSS BW, for example, prior to a dynamic BSS BW change from the first dynamic BSS BW to a second dynamic BSS BW different from the first dynamic BSS BW, e.g., as described below.

In some demonstrative aspects, controller 124 may be configured to control, trigger, cause, and/or instruct the AP implemented by device 102 to configure a DSO setting for the second dynamic BSS BW, for example, based on a requirement that a future DSO sub-band for the DSO STA in the second dynamic BSS BW is to be renegotiated between the AP and the DSO STA, for example, unless a predefined criterion is met, e.g., as described below.

In some demonstrative aspects, controller 124 may be configured to control, trigger, cause, and/or instruct the AP implemented by device 102 to transmit a DBE announcement frame to announce the dynamic BSS BW change from the first dynamic BSS BW to the second dynamic BSS BW, e.g., as described below.

In some demonstrative aspects, controller 124 may be configured to control, trigger, cause, and/or instruct the AP implemented by device 102 to wait for expiration of a time period, for example, after announcing the dynamic BSS BW change and prior to performing a DSO functionality over the second dynamic BSS BW, e.g., as described below.

In some demonstrative aspects, controller 124 may be configured to control, trigger, cause, and/or instruct the AP implemented by device 102 to determine the time period based on capability information from the DSO STA, e.g., as described below.

In some demonstrative aspects, the time period is predefined, for example, according to a standard and/or protocol, e.g., as described below.

In some demonstrative aspects, controller 124 may be configured to allow the AP implemented by device 102 to configure the future DSO sub-band for the DSO STA in the second dynamic BSS BW without a DSO renegotiation, e.g., as described below.

In some demonstrative aspects, controller 124 may be configured to allow the AP implemented by device 102 to configure the future DSO sub-band for the DSO STA in the second dynamic BSS BW without a DSO renegotiation, for example, based on a determination that the current DSO sub-band is part of the second dynamic BSS BW, e.g., as described below.

In some demonstrative aspects, controller 124 may be configured to allow the AP implemented by device 102 to configure the future DSO sub-band for the DSO STA to include a particular DSO sub-band in the second dynamic BSS BW without a DSO renegotiation, for example, based on a determination that there is no other possible sub-band for DSO in the second dynamic BSS BW, e.g., as described below.

In some demonstrative aspects, controller 124 may be configured to control, trigger, cause, and/or instruct the AP implemented by device 102 to wait for expiration of a time period, for example, prior to performing a DSO functionality over the particular channel, e.g., as described below.

In some demonstrative aspects, controller 124 may be configured to control, trigger, cause, and/or instruct the AP implemented by device 102 to determine the time period based on capability information from the DSO STA, e.g., as described below.

In some demonstrative aspects, the time period is predefined, for example, according to a standard and/or protocol, e.g., as described below.

In some demonstrative aspects, controller 124 may be configured to control, trigger, cause, and/or instruct the AP implemented by device 102 to configure the DSO setting for the second dynamic BSS BW, for example, by disabling DSO over the second dynamic BSS BW, for example, based on a determination that there is no possible sub-band for DSO in the second dynamic BSS BW, e.g., as described below.

In some demonstrative aspects, controller 124 may be configured to control, trigger, cause, and/or instruct the AP implemented by device 102 to set a DSO field in the DBE announcement frame to indicate the DSO setting for the second dynamic BSS BW, e.g., as described below.

In some demonstrative aspects, the DBE announcement frame may include a unicast DBE announcement frame addressed to the DSO STA, e.g., as described below.

In some demonstrative aspects, the DSO sub-band field in the unicast DBE announcement frame may be configured to indicate the future DSO sub-band within the second dynamic BSS BW for the DSO STA, e.g., as described below.

In some demonstrative aspects, the DBE announcement frame may include a broadcast DBE announcement frame, e.g., as described below.

In some demonstrative aspects, the DSO sub-band field in the broadcast DBE announcement frame may be configured to indicate an allocation of a plurality of DSO sub-bands in the second dynamic BSS BW to a plurality of DSO STAs, e.g., as described below.

In some demonstrative aspects, the DSO sub-band field in the broadcast DBE announcement frame may be configured to indicate an allocation of a same DSO sub-band in the second dynamic BSS BW to a plurality of DSO STAs, e.g., as described below.

In some demonstrative aspects, controller 124 may be configured to control, trigger, cause, and/or instruct the AP implemented by device 102 to set an enablement field in the DBE announcement frame, for example, to indicate whether DSO is to be enabled or disabled in the second dynamic BSS BW, e.g., as described below.

In some demonstrative aspects, controller 124 may be configured to control, trigger, cause, and/or instruct the AP implemented by device 102 to set one or more BW-specific fields in a DSO frame to negotiate DSO with the DSO STA with respect to one or more dynamic BSS BWs, respectively, e.g., as described below.

In some demonstrative aspects, a BW-specific field of the one or more BW-specific fields may be configured to indicate one or more DSO sub-bands for a dynamic BSS BW of the one or more dynamic BSS BWs, e.g., as described below.

In some demonstrative aspects, device 102, device 140, and/or device 160 may be configured to implement one or more operations and/or functionalities of a dynamic bandwidth mechanism, which may be configured to support a DSO mechanism, e.g., as described below.

For example, the DSO mechanism may include a negotiation of one or more DSO subbands (also referred to as “DSO channels”), e.g., a selection of only a limited set of DSO subbands, which may be used by DSO STAs.

For example, an 80 MHz-only STA, which has a maximal BW limited to 80 MHz, that is DSO capable within a 320 MHz BSS, may be capable of operating with DSO, for example, only with one secondary 80 MHz, e.g., out of the 3 secondary 80 MHz channels that are available within the 320 MHz BW. For example, a DSO protocol may define a way for the AP and the STA to perform a negotiation, for example, to converge towards the usage of only one secondary channel (DSO subband) for this DSO STA. For example, the DSO subband (channel) may include the 2nd secondary 80 MHz channel, which is in the secondary 160 MHz portion of the BSS BW.

For example, the AP may decide to apply the dynamic BSS BW, for example, to shrink the BSS BW to 160 MHz only. Accordingly, the 2nd secondary 80 MHz channel may no longer be available, and the DSO channel for the DSO STA may be updated.

In some demonstrative aspects, device 102, device 140, and/or device 160 may be configured to implement one or more operations and/or functionalities of a dynamic bandwidth mechanism, which may define one or more, e.g., some or all, of the following rules:
If an AP dynamically changes the Dynamic BSS BW for associated DSO UHR STAs, then, the negotiation of the DSO subband (channel) needs to be re-performed, unless the DSO subband (channel) is still part of the new Dynamic BSS BW;
If in a new Dynamic BSS BW (e.g., the Dynamic BSS BW to which the AP changes), there is only one possible DSO subband (channel), then this directly becomes the DSO subband (channel), e.g., without the need for an explicit negotiation;
   For example, it may be defined that the time before being able to use DSO on the new subband (channel) can be signaled by the STA with its capabilities (in case it needs more time), or may be defined in the spec;
If in the new Dynamic BSS BW, there is no possible DSO subbands (channels), then DSO is disabled;
If in the new Dynamic BSS BW, there are multiple DSO subbands (channels), then there may be a re-negotiation of the DSO subband (channel) for one or more STAs, e.g., for each STA.

In some demonstrative aspects, device 102, device 140, and/or device 160 may be configured to implement one or more operations and/or functionalities of a dynamic bandwidth mechanism, which may define that, for example, if there is a change of DSO subband (channel) with the change of Dynamic BSS BW, then there may be a period of time during which DSO is not used. For example, this time period may include, or may be based on a time needed for the STA to recalibrate to the new DSO subband (channel). For example, this time can be defined in the standard, or advertised in the capabilities of the STA and/or the capabilities of the AP.

In some demonstrative aspects, device 102, device 140, and/or device 160 may be configured to implement one or more operations and/or functionalities of a dynamic bandwidth mechanism, which may define one or more rules, which may be configured to provide a technical solution to improve, e.g., optimize, the transition between the DSO subbands, e.g., as described below.

In some demonstrative aspects, it may be defined according to the dynamic bandwidth mechanism, for example, that DSO subband signaling information, e.g., in the form of a reconfiguration Information Element (IE) and/or a DSO IE, is to be included in a frame that announces the change of Dynamic BSS BW.

For example, the frame that announces the change of Dynamic BSS BW may include a reconfiguration frame.

For example, the frame that announces the change of Dynamic BSS BW may include an announcement frame, e.g., a DBE announcement frame, or the like.

For example, the frame that announces the change of Dynamic BSS BW may include a unicast frame, which may be addressed to the DSO STA.

For example, the frame that announces the change of Dynamic BSS BW may include a broadcast frame, e.g., a beacon frame or the like, which may be broadcasted by the AP, for example, to all associated STAs.

In some demonstrative aspects, the DSO subband signaling information may be configured to define what will be the DSO channel (the “new DSO subband”) once the Dynamic BSS BW will be changed to the new BW.

In some demonstrative aspects, it may be defined according to the dynamic bandwidth mechanism, for example, that in case the frame that announces the change of Dynamic BSS BW is a unicasted frame addressed to a STA, then the DSO subband signaling information is to be configured to indicate the DSO subband (channel) for the STA.

In some demonstrative aspects, it may be defined according to the dynamic bandwidth mechanism, for example, that the DSO subband (channel) for the STA may be negotiated with a response from the STA, e.g., prior to the dynamic BSS BW change.

In some demonstrative aspects, it may be defined according to the dynamic bandwidth mechanism, for example, that in case the frame that announces the change of Dynamic BSS BW is a broadcast frame, then the DSO subband signaling information is to be configured to indicate one or more DSO subbands (channels), e.g., as described below.

In some demonstrative aspects, it may be defined according to the dynamic bandwidth mechanism, for example, that in case the frame that announces the change of Dynamic BSS BW is a broadcast frame, then the DSO subband signaling information may be configured to indicate a list of candidate DSO subbands (channels), e.g., which may be potential DSO subbands (channels) for negotiation with one or more STAs.

In some demonstrative aspects, it may be defined according to the dynamic bandwidth mechanism, for example, that in case the frame that announces the change of Dynamic BSS BW is a broadcast frame, then the DSO subband signaling information may be configured to indicate a list of DSO subbands (channels). For example, a DSO subband (channel), e.g., each DSO subband (channel), may be signaled with association information to indicate one or more STAs to be assigned with the DSO subband (channel). For example, the association information for a new DSO subband (channel) may include an Association Identifier (AID) bitmap, which may be configured to indicate a list of AIDs that will be assigned with the new DSO subband (channel).

In some demonstrative aspects, it may be defined according to the dynamic bandwidth mechanism, for example, that in case the frame that announces the change of Dynamic BSS BW is a broadcast frame, then the DSO subband signaling information may be configured to indicate a DSO subband (channel), e.g., only one DSO subband (channel), which is to be assigned to all STAs.

In some demonstrative aspects, it may be defined according to the dynamic bandwidth mechanism, for example, that a STA and the AP may be allowed to re-negotiate the new DSO subband(s) (channel(s)) that will be used by the STA on the new dynamic BW, for example, before the change of the dynamic BW occurs.

For example, it may be defined that the STA and the AP may be allowed to re-negotiate the new DSO subband(s) (channel(s)), for example, in case the frame that announces the change of Dynamic BSS BW is a broadcast frame.

For example, it may be defined that the STA and the AP may be allowed to re-negotiate the new DSO subband(s) (channel(s)), for example, by exchanging one or more negotiation frames, e.g., a request frame and/or a response frame, which may be configured for DSO channel negotiation.

For example, it may be defined that an indication, e.g., an explicit indication, is to be included in the negotiation frames, e.g., request and/or response, to indicate that the negotiation of the DSO subband(s) (channel(s)) is to apply for the new upcoming Dynamic BSS BW.

In some demonstrative aspects, it may be defined according to the dynamic bandwidth mechanism, for example, that a plurality of possible DSO subband(s) (channel(s)) may be negotiated for a plurality of possible Dynamic BSS BWs, e.g., as described below.

In some demonstrative aspects, it may be defined according to the dynamic bandwidth mechanism, for example, that a plurality of possible DSO subband(s) (channel(s)) for a plurality of possible Dynamic BSS BW that will occur in the future may be negotiated together, e.g., in one shot.

In some demonstrative aspects, it may be defined according to the dynamic bandwidth mechanism, for example, that all the possible DSO subband(s) (channel(s)) for all possible Dynamic BSS BW that will occur in the future may be negotiated together, e.g., in one shot.

For example, DSO frames that are used to announce and/or negotiate the DSO subband(s) (channel(s)) of an associated STA may be configured, for example, to support joint negotiating of BW-specific DSO subband(s) (channel(s)).

For example, a DSO frame may be configured to support signaling of one or more DSO subbands (channels) associated with a dynamic BSS BW, e.g., on a per-BW basis.

In one example, a DSO frame may be configured to support signaling of one or more first DSO subbands (channels) associated with a first dynamic BSS BW, one or more second DSO subbands associated with a second dynamic BSS BW, and so on.

For example, a DSO frame may be configured to include one or more information subelements corresponding to one or more dynamic BSS BWs. For example, an information subelement, e.g., each information subelement, may include a list of one or more DSO channels associated with a BW field, which is to indicate a particular dynamic BSS BW.

In one example, a DSO frame may include a first information subelement associated with a first BW field to indicate a first dynamic BSS BW, where the first information subelement may include a first list of one or more first DSO subbands associated with the first dynamic BSS BW; a second information subelement associated with a second BW field to indicate a second dynamic BSS BW, where the second information subelement may include a second list of one or more second DSO subbands associated with the second dynamic BSS BW; and so on.

In some demonstrative aspects, it may be defined according to the dynamic bandwidth mechanism, for example, that an AP may be allowed to disable or enable DSO on the new Dynamic BSS BW, for example, simultaneously with the BSS BW change announcement.

For example, it may be defined that the AP may set a field (“DSO enable/disable field”) in an announcement frame, which includes the BSS BW change announcement, to indicate whether DSO is to be enabled or disabled over the new Dynamic BSS BW, which is being announced by the dynamic BSS BW change announcement.

In one example, the AP may set the DSO enable/disable field in an announcement frame to a first predefined value, e.g., 0, to indicate that DSO is to be disabled over the new Dynamic BSS BW, which is being announced by the announcement frame.

In one example, the AP may set the DSO enable/disable field in an announcement frame to a second predefined value, e.g., 1, to indicate that DSO is to be enabled over the new Dynamic BSS BW, which is being announced by the announcement frame.

In some demonstrative aspects, it may be defined according to the dynamic bandwidth mechanism, for example, that if the AP, which announces the change of the Dynamic BSS BW, is affiliated with an AP MLD, then all APs affiliated with the AP MLD will also announce the Dynamic BSS BW update as well as the new DSO subband(s).

In some demonstrative aspects, device 102, device 140, and/or device 160 may be configured to implement one or more operations and/or functionalities of a dynamic bandwidth mechanism, which may be configured to support an NPCA mechanism, e.g., as described below.

For example, the NPCA mechanism may utilize an NPCA Primary Channel. For example, the NPCA channel may include a channel to which STAs/AP will switch based on one or more NPCA conditions, e.g., an Overlapping BSS (OBSS) transmission detected on a primary channel and occupying only a limited BW.

In one example, it may be defined that a single NPCA primary channel may be selected and announced/advertised by an AP, e.g., without negotiation.

For example, in some cases the NPCA primary channel may be impacted by a Dynamic BSS BW change.

In some demonstrative aspects, it may be defined according to the dynamic bandwidth mechanism, for example, that if an AP announces an upcoming change of Dynamic BSS BW, then the AP should also announce the change of NPCA Primary Channel at the same time.

In some demonstrative aspects, it may be defined according to the dynamic bandwidth mechanism, for example, that when the time for the change of the dynamic BSS BW is reached, both the Dynamic BSS BW and the NPCA Primary Channel are to be changed, e.g., simultaneously.

For example, an AP may operate with a current Dynamic BSS BW of 160 MHz, and an NPCA channel corresponding to a 5th 20 MHz channel, e.g., in the secondary 80 MHz of the 160 MHz BW. For example, the AP may transition to a Dynamic BSS BW of 320 MHz, and an NPCA channel corresponding to a 9th 20 MHz channel, e.g., in the secondary 160 MHz of the 320 MHz BW.

In some demonstrative aspects, it may be defined according to the dynamic bandwidth mechanism, for example, that the indication/signaling of NPCA Primary Channel corresponding to the new Dynamic BSS BW will be included in the same element carrying the Dynamic BSS BW announcement, or in a separate element in the same frame carrying the announcement of the change of the Dynamic BSS BW.

In some demonstrative aspects, it may be defined according to the dynamic bandwidth mechanism, for example, that if the AP, which announces the change of the Dynamic BSS BW, is affiliated with an AP MLD, then all APs affiliated with the AP MLD will also announce the Dynamic BSS BW update as well as the new NPCA primary channel.

In some demonstrative aspects, it may be defined according to the dynamic bandwidth mechanism, for example, that an AP may be allowed to disable or enable NPCA on the new Dynamic BSS BW, for example, simultaneously with the BSS BW change announcement.

For example, it may be defined that the AP may set a field (“NPCA enable/disable field”) in an announcement frame, which includes the dynamic BSS BW change announcement, to indicate whether NPCA is to be enabled or disabled over the new Dynamic BSS BW, which is being announced by the dynamic BSS BW change announcement.

In one example, the AP may set the NPCA enable/disable field in an announcement frame to a first predefined value, e.g., 0, to indicate that NPCA is to be disabled over the new Dynamic BSS BW, which is being announced by the announcement frame.

In one example, the AP may set the NPCA enable/disable field in an announcement frame to a second predefined value, e.g., 1, to indicate that NPCA is to be enabled over the new Dynamic BSS BW, which is being announced by the announcement frame.

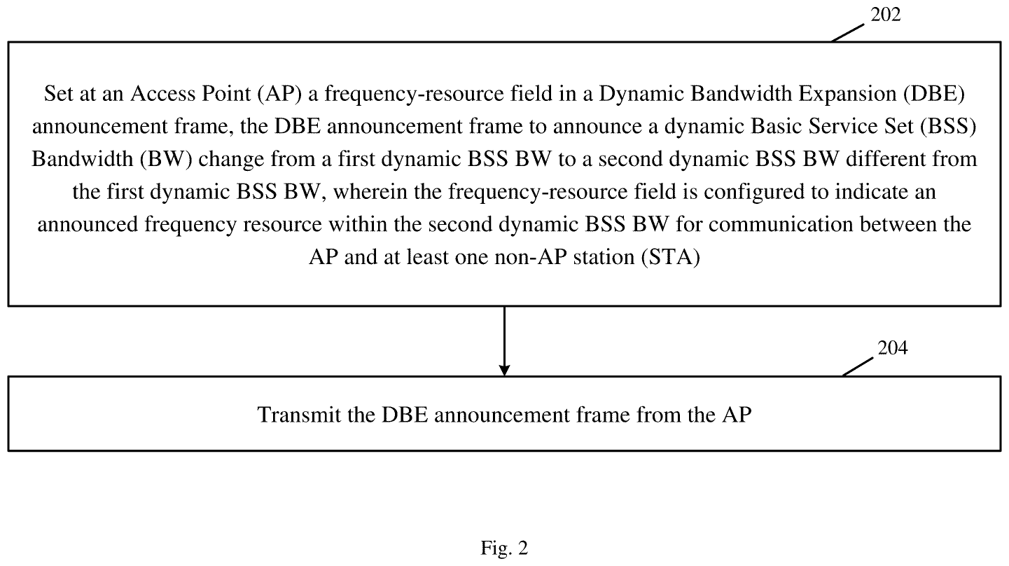

Reference is made to FIG. 2, which schematically illustrates a method of dynamic bandwidth, in accordance with some demonstrative aspects. For example, one or more of the operations of the method of FIG. 2 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 202, the method may include setting at an AP a frequency-resource field in a DBE announcement frame, the DBE announcement frame to announce a dynamic BSS BW change from a first dynamic BSS BW to a second dynamic BSS BW different from the first dynamic BSS BW. For example, the frequency-resource field may be configured to indicate an announced frequency resource within the second dynamic BSS BW for communication between the AP and at least one non-AP STA. For example, controller 124 (FIG. 1) may be configured to cause, trigger, and/or control the AP implemented by device 102 (FIG. 1) to set the frequency-resource field in the DBE announcement frame to indicate the announced frequency resource within the second dynamic BSS BW for communication between the AP and the at least one non-AP STA, e.g., as described above.

As indicated at block 204, the method may include transmitting the DBE announcement frame from the AP. For example, controller 124 (FIG. 1) may be configured to cause, trigger, and/or control the AP implemented by device 102 (FIG. 1) to transmit the DBE announcement frame including the frequency-resource field, e.g., as described above.

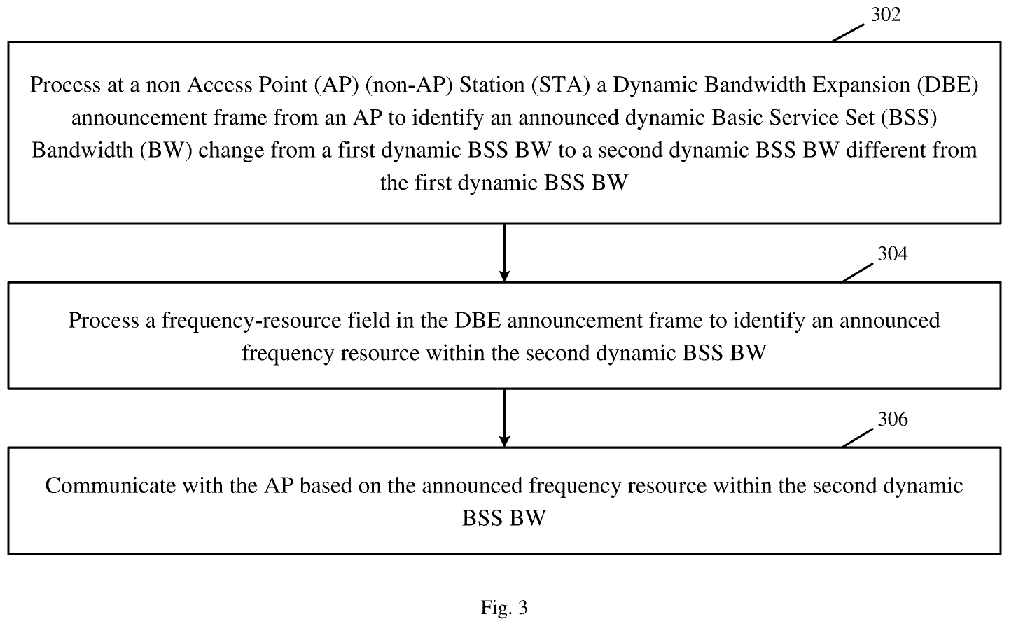

Reference is made to FIG. 3, which schematically illustrates a method of dynamic bandwidth, in accordance with some demonstrative aspects. For example, one or more of the operations of the method of FIG. 3 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 302, the method may include processing at a non-AP STA a DBE announcement frame from an AP to identify an announced dynamic BSS BW change from a first dynamic BSS BW to a second dynamic BSS BW different from the first dynamic BSS BW. For example, controller 154 (FIG. 1) may be configured to cause, trigger, and/or control the non-AP STA implemented by device 140 (FIG. 1) to process the DBE announcement frame from the AP implemented by device 102 (FIG. 1), for example, to identify the announced dynamic BSS BW change from the first dynamic BSS BW to the second dynamic BSS BW, e.g., as described above.

As indicated at block 304, the method may include processing a frequency-resource field in the DBE announcement frame to identify an announced frequency resource within the second dynamic BSS BW. For example, controller 154 (FIG. 1) may be configured to cause, trigger, and/or control the non-AP STA implemented by device 140 (FIG. 1) to process the frequency-resource field in the DBE announcement frame, for example, to identify the announced frequency resource within the second dynamic BSS BW, e.g., as described above.

As indicated at block 306, the method may include communicating with the AP based on the announced frequency resource within the second dynamic BSS BW. For example, controller 154 (FIG. 1) may be configured to cause, trigger, and/or control the non-AP STA implemented by device 140 (FIG. 1) to communicate with the AP implemented by device 102 (FIG. 1), for example, based on the announced frequency resource within the second dynamic BSS BW, e.g., as described above.

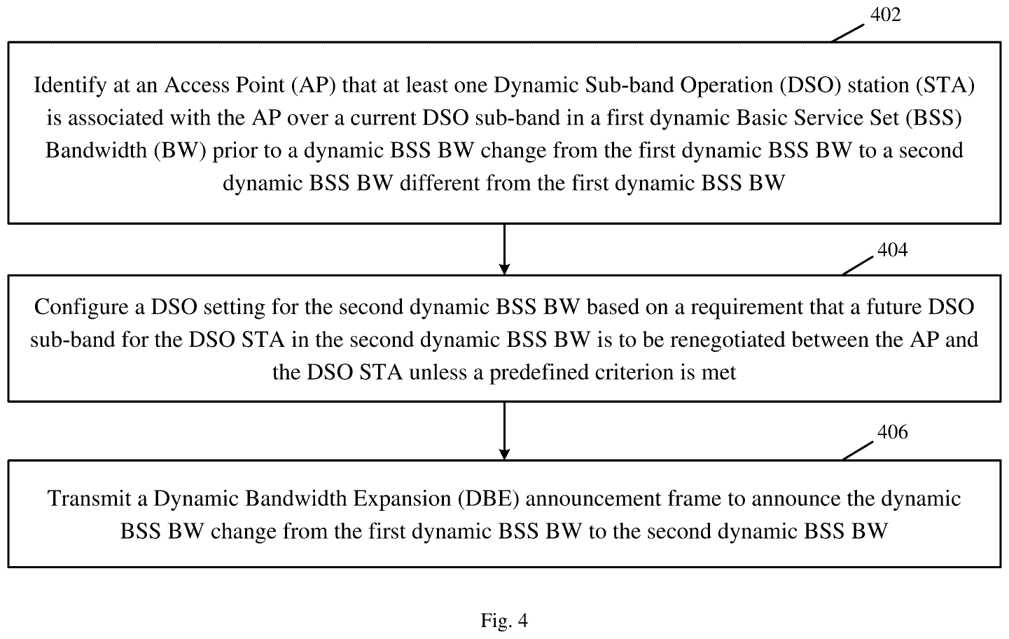

Reference is made to FIG. 4, which schematically illustrates a method of dynamic bandwidth, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include identifying at an AP that at least one DSO STA is associated with the AP over a current DSO sub-band in a first dynamic BSS BW prior to a dynamic BSS BW change from the first dynamic BSS BW to a second dynamic BSS BW different from the first dynamic BSS BW. For example, controller 124 (FIG. 1) may be configured to cause, trigger, and/or control the AP implemented by device 102 (FIG. 1) to identify that at least one DSO STA is associated with the AP over a current DSO sub-band in the first dynamic BSS BW, for example, prior to the dynamic BSS BW change from the first dynamic BSS BW to the second dynamic BSS BW, e.g., as described above.

As indicated at block 404, the method may include configuring a DSO setting for the second dynamic BSS BW based on a requirement that a future DSO sub-band for the DSO STA in the second dynamic BSS BW is to be renegotiated between the AP and the DSO STA unless a predefined criterion is met. For example, controller 124 (FIG. 1) may be configured to cause, trigger, and/or control the AP implemented by device 102 (FIG. 1) to configure the DSO setting for the second dynamic BSS BW, for example, based on the requirement that the future DSO sub-band for the DSO STA in the second dynamic BSS BW is to be renegotiated between the AP and the DSO STA unless a predefined criterion is met, e.g., as described above.

As indicated at block 406, the method may include transmitting a DBE announcement frame to announce the dynamic BSS BW change from the first dynamic BSS BW to the second dynamic BSS BW. For example, controller 124 (FIG. 1) may be configured to cause, trigger, and/or control the AP implemented by device 102 (FIG. 1) to transmit the DBE announcement frame to announce the dynamic BSS BW change from the first dynamic BSS BW to the second dynamic BSS BW, e.g., as described above.

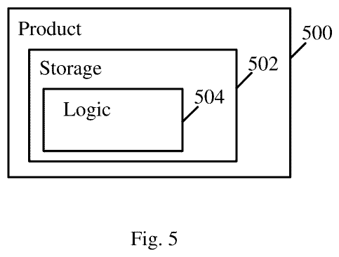

Reference is made to FIG. 5, which schematically illustrates a product of manufacture 500, in accordance with some demonstrative aspects. Product 500 may include one or more tangible computer-readable (“machine-readable”) non-transitory storage media 502, which may include computer-executable instructions, e.g., implemented by logic 504, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-4, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 500 and/or machine readable storage media 502 may include one or more types of computer-readable storage media capable of storing data, including volatile memory, non-volatile memory, removable or non-removable memory, erasable or non-erasable memory, writeable or re-writeable memory, and the like. For example, machine readable storage media 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to cause an Access Point (AP) to set a frequency-resource field in a Dynamic Bandwidth Expansion (DBE) announcement frame, the DBE announcement frame to announce a dynamic Basic Service Set (BSS) Bandwidth (BW) change from a first dynamic BSS BW to a second dynamic BSS BW different from the first dynamic BSS BW, wherein the frequency-resource field is configured to indicate an announced frequency resource within the second dynamic BSS BW for communication between the AP and at least one non-AP station (STA); and transmit the DBE announcement frame; and a memory to store information processed by the processor.

Example 2 includes the subject matter of Example 1, and optionally, wherein the frequency-resource field is configured to indicate an announced Dynamic Sub-band Operation (DSO) sub-band within the second dynamic BSS BW for a DSO STA functionality of the non-AP STA, the announced DSO sub-band is outside an operating BW of the DSO STA.

Example 3 includes the subject matter of Example 2, and optionally, wherein the announced DSO sub-band within the second dynamic BSS BW is different from a current DSO sub-band within the first dynamic BSS BW.

Example 4 includes the subject matter of Example 2 or 3, and optionally, wherein the apparatus is configured to cause the AP to determine the announced DSO sub-band within the second dynamic BSS BW based on a DSO re-negotiation with the non-AP STA.

Example 5 includes the subject matter of any one of Examples 2-4, and optionally, wherein the apparatus is configured to cause the AP to determine the announced DSO sub-band within the second dynamic BSS BW to be the same as a current DSO sub-band within the first dynamic BSS BW when the current DSO sub-band is within the second dynamic BSS BW.

Example 6 includes the subject matter of any one of Examples 2-5, and optionally, wherein the apparatus is configured to cause the AP to determine that the announced DSO sub-band within the second dynamic BSS BW is to comprise a particular channel in the second dynamic BSS BW when there is no other possible sub-band for DSO in the second dynamic BSS BW.

Example 7 includes the subject matter of Example 6, and optionally, wherein the apparatus is configured to cause the AP to wait for expiration of a time period after transmission of the DBE announcement frame and prior to performing a DSO functionality over the particular channel.

Example 8 includes the subject matter of Example 7, and optionally, wherein the apparatus is configured to cause the AP to determine the time period based on capability information from the non-AP STA.

Example 9 includes the subject matter of Example 7, and optionally, wherein the time period is predefined.

Example 10 includes the subject matter of any one of Examples 2-9, and optionally, wherein the apparatus is configured to cause the AP to wait for expiration of a time period after transmission of the DBE announcement frame and prior to performing a DSO functionality.

Example 11 includes the subject matter of Example 10, and optionally, wherein the apparatus is configured to cause the AP to determine the time period based on capability information from the non-AP STA.

Example 12 includes the subject matter of Example 10, and optionally, wherein the time period is predefined.

Example 13 includes the subject matter of any one of Examples 2-12, and optionally, wherein the apparatus is configured to cause the AP to set an enablement field in the DBE announcement frame to indicate whether DSO is to be enabled or disabled in the second dynamic BSS BW.

Example 14 includes the subject matter of any one of Examples 2-13, and optionally, wherein the apparatus is configured to cause the AP to set the frequency-resource field to indicate a particular DSO sub-band for a particular non-AP STA, and to transmit the DBE announcement frame as a unicast frame addressed to the particular non-AP STA.

Example 15 includes the subject matter of any one of Examples 2-13, and optionally, wherein the apparatus is configured to cause the AP to set the frequency-resource field to indicate a plurality of candidate DSO sub-bands in the second dynamic BSS BW, and to transmit the DBE announcement frame as a broadcast frame.

Example 16 includes the subject matter of any one of Examples 2-13, and optionally, wherein the apparatus is configured to cause the AP to set the frequency-resource field to indicate an allocation of a plurality of DSO sub-bands in the second dynamic BSS BW to a plurality of non-AP STAs, and to transmit the DBE announcement frame as a broadcast frame.

Example 17 includes the subject matter of any one of Examples 2-13, and optionally, wherein the apparatus is configured to cause the AP to set the frequency-resource field to indicate an allocation of a same DSO sub-band in the second dynamic BSS BW to a plurality of non-AP STAs, and to transmit the DBE announcement frame as a broadcast frame.

Example 18 includes the subject matter of Example 1, and optionally, wherein the frequency-resource field is configured to indicate an announced Non-Primary Channel Access (NPCA) primary channel within the second dynamic BSS BW, the announced NPCA primary channel configured for NPCA operation over a non-primary channel in the second dynamic BSS BW.

Example 19 includes the subject matter of Example 18, and optionally, wherein the announced NPCA primary channel within the second dynamic BSS BW is different from a current NPCA primary channel within the first dynamic BSS BW.

Example 20 includes the subject matter of Example 18 or 19, and optionally, wherein the apparatus is configured to cause the AP to set an enablement field in the DBE announcement frame to indicate whether NPCA is to be enabled or disabled in the second dynamic BSS BW.

Example 21 includes the subject matter of any one of Examples 1-20, and optionally, wherein the announced frequency resource is different from a current frequency resource within the first dynamic BSS for communication between the AP and the non-AP STA.

Example 22 includes the subject matter of any one of Examples 1-21, and optionally, wherein the announced frequency resource is outside the first dynamic BSS BW.

Example 23 includes the subject matter of any one of Examples 1-21, and optionally, wherein the announced frequency resource is within the first dynamic BSS BW.

Example 24 includes the subject matter of any one of Examples 1-23, and optionally, wherein the apparatus is configured to cause all APs affiliated with a same AP Multi Link Device (MLD) to transmit DBE announcement frames comprising the frequency-resource field to indicate the announced frequency resource with the announcement of the dynamic BSS BW change from the first dynamic BSS BW to the second dynamic BSS BW.

Example 25 includes the subject matter of any one of Examples 1-24, and optionally, wherein the DBE announcement frame is configured to announce a dynamic BSS BW expansion from the first dynamic BSS BW to the second dynamic BSS BW, the second dynamic BSS BW is wider than the first dynamic BSS BW.

Example 26 includes the subject matter of any one of Examples 1-24, and optionally, wherein the DBE announcement frame is configured to announce a dynamic BSS BW reduction from the first dynamic BSS BW to the second dynamic BSS BW, the second dynamic BSS BW is narrower than the first dynamic BSS BW.

Example 27 includes the subject matter of any one of Examples 1-26, and optionally, wherein the AP comprises an Ultra High Reliability (UHR) AP.

Example 28 includes the subject matter of any one of Examples 1-27, and optionally, comprising a radio to transmit the DBE announcement frame.

Example 29 includes the subject matter of Example 28, and optionally, comprising one or more antennas connected to the radio, and another processor to execute instructions of an operating system.

Example 30 includes an apparatus comprising a processor configured to cause a non Access Point (AP) (non-AP) station (STA) to process a Dynamic Bandwidth Expansion (DBE) announcement frame from an AP to identify an announced dynamic Basic Service Set (BSS) Bandwidth (BW) change from a first dynamic BSS BW to a second dynamic BSS BW different from the first dynamic BSS BW; process a frequency-resource field in the DBE announcement frame to identify an announced frequency resource within the second dynamic BSS BW; and communicate with the AP based on the announced frequency resource within the second dynamic BSS BW; and a memory to store information processed by the processor.

Example 31 includes the subject matter of Example 30, and optionally, wherein the frequency-resource field is configured to indicate an announced Dynamic Sub-band Operation (DSO) sub-band within the second dynamic BSS BW for a DSO STA functionality of the non-AP STA, the announced DSO sub-band is outside an operating BW of the DSO STA.

Example 32 includes the subject matter of Example 31, and optionally, wherein the announced DSO sub-band within the second dynamic BSS BW is different from a current DSO sub-band within the first dynamic BSS BW.

Example 33 includes the subject matter of Example 31 or 32, and optionally, wherein the apparatus is configured to cause the non-AP STA to negotiate the announced DSO sub-band within the second dynamic BSS BW based on a DSO re-negotiation with the AP.

Example 34 includes the subject matter of any one of Examples 31-33, and optionally, wherein the apparatus is configured to cause the non-AP STA to identify the announced DSO sub-band within the second dynamic BSS BW to be the same as a current DSO sub-band within the first dynamic BSS BW when the current DSO sub-band is within the second dynamic BSS BW.

Example 35 includes the subject matter of any one of Examples 31-34, and optionally, wherein the apparatus is configured to cause the non-AP STA to determine that the announced DSO sub-band within the second dynamic BSS BW is to comprise a particular channel in the second dynamic BSS BW when there is no other possible sub-band for DSO in the second dynamic BSS BW.

Example 36 includes the subject matter of Example 35, and optionally, wherein the apparatus is configured to cause the non-AP STA to transmit to the AP capability information to indicate a time period that the AP is to wait before performing a DSO functionality over the particular channel following transmission of the DBE announcement frame.

Example 37 includes the subject matter of any one of Examples 31-36, and optionally, wherein the apparatus is configured to cause the non-AP STA to transmit to the AP capability information to indicate a time period that the AP is to wait before performing a DSO functionality following transmission of the DBE announcement frame.

Example 38 includes the subject matter of any one of Examples 31-37, and optionally, wherein the apparatus is configured to cause the non-AP STA to process an enablement field in the DBE announcement frame to identify whether DSO is to be enabled or disabled in the second dynamic BSS BW.

Example 39 includes the subject matter of any one of Examples 31-38, and optionally, wherein the apparatus is configured to cause the non-AP to identify that the DBE announcement frame is a unicast frame addressed to the particular non-AP STA, and to process the frequency-resource field to identify a particular DSO sub-band for the non-AP STA.

Example 40 includes the subject matter of any one of Examples 31-38, and optionally, wherein the apparatus is configured to cause the non-AP to identify that the DBE announcement frame is a broadcast frame, and to process the frequency-resource field to identify a plurality of candidate DSO sub-bands in the second dynamic BSS BW.

Example 41 includes the subject matter of any one of Examples 31-38, and optionally, wherein the apparatus is configured to cause the non-AP to identify that the DBE announcement frame is a broadcast frame, and to process the frequency-resource field to identify an allocation of a DSO sub-band for the non-AP STA in a plurality of DSO sub-bands in the second dynamic BSS BW allocated to a plurality of non-AP STAs.

Example 42 includes the subject matter of any one of Examples 31-38, and optionally, wherein the apparatus is configured to cause the non-AP to identify that the DBE announcement frame is a broadcast frame, and to process the frequency-resource field to identify an allocation of a same DSO sub-band in the second dynamic BSS BW to a plurality of non-AP STAs comprising the non-AP STA.

Example 43 includes the subject matter of Example 30, and optionally, wherein the frequency-resource field is configured to indicate an announced Non-Primary Channel Access (NPCA) primary channel within the second dynamic BSS BW, the announced NPCA primary channel configured for NPCA operation over a non-primary channel in the second dynamic BSS BW.

Example 44 includes the subject matter of Example 43, and optionally, wherein the announced NPCA primary channel within the second dynamic BSS BW is different from a current NPCA primary channel within the first dynamic BSS BW.

Example 45 includes the subject matter of Example 43 or 44, and optionally, wherein the apparatus is configured to cause the non-AP STA to process an enablement field in the DBE announcement frame to identify whether NPCA is to be enabled or disabled in the second dynamic BSS BW.

Example 46 includes the subject matter of any one of Examples 30-45, and optionally, wherein the announced frequency resource is different from a current frequency resource within the first dynamic BSS for communication between the AP and the non-AP STA.

Example 47 includes the subject matter of any one of Examples 30-46, and optionally, wherein the announced frequency resource is outside the first dynamic BSS BW.

Example 48 includes the subject matter of any one of Examples 30-46, and optionally, wherein the announced frequency resource is within the first dynamic BSS BW.

Example 49 includes the subject matter of any one of Examples 30-48, and optionally, wherein the DBE announcement frame is configured to announce a dynamic BSS BW expansion from the first dynamic BSS BW to the second dynamic BSS BW, the second dynamic BSS BW is wider than the first dynamic BSS BW.

Example 50 includes the subject matter of any one of Examples 30-49, and optionally, wherein the DBE announcement frame is configured to announce a dynamic BSS BW reduction from the first dynamic BSS BW to the second dynamic BSS BW, the second dynamic BSS BW is narrower than the first dynamic BSS BW.

Example 51 includes the subject matter of any one of Examples 30-50, and optionally, wherein the non-AP STA comprises an Ultra High Reliability (UHR) non-AP STA.

Example 52 includes the subject matter of any one of Examples 30-51, and optionally, comprising a radio to receive the DBE announcement frame.

Example 53 includes the subject matter of Example 52, and optionally, comprising one or more antennas connected to the radio, and another processor to execute instructions of an operating system.

Example 54 includes an apparatus comprising a processor configured to cause an Access Point (AP) to identify that at least one Dynamic Sub-band Operation (DSO) station (STA) is associated with the AP over a current DSO sub-band in a first dynamic Basic Service Set (BSS) Bandwidth (BW) prior to a dynamic BSS BW change from the first dynamic BSS BW to a second dynamic BSS BW different from the first dynamic BSS BW; configure a DSO setting for the second dynamic BSS BW based on a requirement that a future DSO sub-band for the DSO STA in the second dynamic BSS BW is to be renegotiated between the AP and the DSO STA unless a predefined criterion is met; and transmit a Dynamic Bandwidth Expansion (DBE) announcement frame to announce the dynamic BSS BW change from the first dynamic BSS BW to the second dynamic BSS BW; and a memory to store information processed by the processor.

Example 55 includes the subject matter of Example 54, and optionally, wherein the apparatus is configured to allow the AP to configure the future DSO sub-band for the DSO STA in the second dynamic BSS BW without a DSO renegotiation based on a determination that the current DSO sub-band is part of the second dynamic BSS BW.

Example 56 includes the subject matter of Example 54 or 55, and optionally, wherein the apparatus is configured to allow the AP to configure the future DSO sub-band for the DSO STA to comprise a particular DSO sub-band in the second dynamic BSS BW without a DSO renegotiation based on a determination that there is no other possible sub-band for DSO in the second dynamic BSS BW.

Example 57 includes the subject matter of Example 56, and optionally, wherein the apparatus is configured to cause the AP to wait for expiration of a time period prior to performing a DSO functionality over the particular channel.

Example 58 includes the subject matter of Example 57, and optionally, wherein the apparatus is configured to cause the AP to determine the time period based on capability information from the DSO STA.

Example 59 includes the subject matter of Example 57, and optionally, wherein the time period is predefined.

Example 60 includes the subject matter of any one of Examples 54-59, and optionally, wherein the apparatus is configured to cause the AP to wait for expiration of a time period after announcing the dynamic BSS BW change and prior to performing a DSO functionality over the second dynamic BSS BW.

Example 61 includes the subject matter of Example 60, and optionally, wherein the apparatus is configured to cause the AP to determine the time period based on capability information from the DSO STA.

Example 62 includes the subject matter of Example 60, and optionally, wherein the time period is predefined.

Example 63 includes the subject matter of any one of Examples 54-62, and optionally, wherein the apparatus is configured to cause the AP to configure the DSO setting for the second dynamic BSS BW by disabling DSO over the second dynamic BSS BW based on a determination that there is no possible sub-band for DSO in the second dynamic BSS BW.

Example 64 includes the subject matter of any one of Examples 54-63, and optionally, wherein the apparatus is configured to cause the AP to set a DSO field in the DBE announcement frame to indicate the DSO setting for the second dynamic BSS BW.

Example 65 includes the subject matter of Example 64, and optionally, wherein the DBE announcement frame comprises a unicast DBE announcement frame addressed to the DSO STA, the DSO sub-band field configured to indicate the future DSO sub-band within the second dynamic BSS BW for the DSO STA.

Example 66 includes the subject matter of Example 64, and optionally, wherein the DBE announcement frame comprises a broadcast DBE announcement frame, the DSO sub-band field configured to indicate an allocation of a plurality of DSO sub-bands in the second dynamic BSS BW to a plurality of DSO STAs.

Example 67 includes the subject matter of Example 64, and optionally, wherein the DBE announcement frame comprises a broadcast DBE announcement frame, the DSO sub-band field configured to indicate an allocation of a same DSO sub-band in the second dynamic BSS BW to a plurality of DSO STAs.

Example 68 includes the subject matter of any one of Examples 54-67, and optionally, wherein the apparatus is configured to cause the AP to set an enablement field in the DBE announcement frame to indicate whether DSO is to be enabled or disabled in the second dynamic BSS BW.

Example 69 includes the subject matter of any one of Examples 54-68, and optionally, wherein the apparatus is configured to cause the AP to set one or more BW-specific fields in a DSO frame to negotiate DSO with the DSO STA with respect to one or more dynamic BSS BWs, respectively, wherein a BW-specific field of the one or more BW-specific fields is configured to indicate one or more DSO sub-bands for a dynamic BSS BW of the one or more dynamic BSS BWs.

Example 70 includes the subject matter of any one of Examples 54-69, and optionally, wherein the AP comprises an Ultra High Reliability (UHR) AP.

Example 71 includes the subject matter of any one of Examples 54-70, and optionally, comprising a radio to transmit the DBE announcement frame.

Example 72 includes the subject matter of Example 71, and optionally, comprising one or more antennas connected to the radio, and another processor to execute instructions of an operating system.

Example 73 includes a wireless communication device comprising the apparatus of any of Examples 1-72.

Example 74 includes a mobile device comprising the apparatus of any of Examples 1-72.

Example 75 includes an apparatus comprising means for executing any of the described operations of any of Examples 1-72.

Example 76 includes a product comprising one or more tangible computer-readable non-transitory storage media comprising instructions operable to, when executed by at least one processor, enable the at least one processor to cause any of the described operations of any of Examples 1-72.

Example 77 includes an apparatus comprising: a memory interface; and processing circuitry configured to: perform any of the described operations of any of Examples 1-72.

Example 78 includes a method comprising any of the described operations of any of Examples 1-72.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause an Access Point (AP) to:
set a frequency-resource field in a Dynamic Bandwidth Expansion (DBE) announcement frame, the DBE announcement frame to announce a dynamic Basic Service Set (BSS) Bandwidth (BW) change from a first dynamic BSS BW to a second dynamic BSS BW different from the first dynamic BSS BW, wherein the frequency-resource field is configured to indicate an announced frequency resource within the second dynamic BSS BW for communication between the AP and at least one non-AP station (STA); and
transmit the DBE announcement frame; and
a memory to store information processed by the processor.

2. The apparatus of claim 1, wherein the frequency-resource field is configured to indicate an announced Dynamic Sub-band Operation (DSO) sub-band within the second dynamic BSS BW for a DSO STA functionality of the non-AP STA, the announced DSO sub-band is outside an operating BW of the DSO STA.

3. The apparatus of claim 2, wherein the announced DSO sub-band within the second dynamic BSS BW is different from a current DSO sub-band within the first dynamic BSS BW.

4. The apparatus of claim 2 configured to cause the AP to determine the announced DSO sub-band within the second dynamic BSS BW based on a DSO re-negotiation with the non-AP STA.

5. The apparatus of claim 2 configured to cause the AP to determine the announced DSO sub-band within the second dynamic BSS BW to be the same as a current DSO sub-band within the first dynamic BSS BW when the current DSO sub-band is within the second dynamic BSS BW.

6. The apparatus of claim 2 configured to cause the AP to determine that the announced DSO sub-band within the second dynamic BSS BW is to comprise a particular channel in the second dynamic BSS BW when there is no other possible sub-band for DSO in the second dynamic BSS BW.

7. The apparatus of claim 2 configured to cause the AP to wait for expiration of a time period after transmission of the DBE announcement frame and prior to performing a DSO functionality.

8. The apparatus of claim 7 configured to cause the AP to determine the time period based on capability information from the non-AP STA.

9. The apparatus of claim 2 configured to cause the AP to set an enablement field in the DBE announcement frame to indicate whether DSO is to be enabled or disabled in the second dynamic BSS BW.

10. The apparatus of claim 2 configured to cause the AP to set the frequency-resource field to indicate a particular DSO sub-band for a particular non-AP STA, and to transmit the DBE announcement frame as a unicast frame addressed to the particular non-AP STA.

11. The apparatus of claim 2 configured to cause the AP to set the frequency-resource field to indicate a plurality of candidate DSO sub-bands in the second dynamic BSS BW, and to transmit the DBE announcement frame as a broadcast frame.

12. The apparatus of claim 2 configured to cause the AP to set the frequency-resource field to indicate an allocation of a plurality of DSO sub-bands in the second dynamic BSS BW to a plurality of non-AP STAs, and to transmit the DBE announcement frame as a broadcast frame.

13. The apparatus of claim 2 configured to cause the AP to set the frequency-resource field to indicate an allocation of a same DSO sub-band in the second dynamic BSS BW to a plurality of non-AP STAs, and to transmit the DBE announcement frame as a broadcast frame.

14. The apparatus of claim 1, wherein the frequency-resource field is configured to indicate an announced Non-Primary Channel Access (NPCA) primary channel within the second dynamic BSS BW, the announced NPCA primary channel configured for NPCA operation over a non-primary channel in the second dynamic BSS BW.

15. The apparatus of claim 14 configured to cause the AP to set an enablement field in the DBE announcement frame to indicate whether NPCA is to be enabled or disabled in the second dynamic BSS BW.

16. The apparatus of claim 1 configured to cause all APs affiliated with a same AP Multi Link Device (MLD) to transmit DBE announcement frames comprising the frequency-resource field to indicate the announced frequency resource with the announcement of the dynamic BSS BW change from the first dynamic BSS BW to the second dynamic BSS BW.

17. The apparatus of claim 1 comprising a radio to transmit the DBE announcement frame, one or more antennas connected to the radio, and another processor to execute instructions of an operating system.

18. A product comprising one or more tangible computer-readable non-transitory storage media comprising instructions operable to, when executed by at least one processor, enable the at least one processor to cause an Access Point (AP) to:
identify that at least one Dynamic Sub-band Operation (DSO) station (STA) is associated with the AP over a current DSO sub-band in a first dynamic Basic Service Set (BSS) Bandwidth (BW) prior to a dynamic BSS BW change from the first dynamic BSS BW to a second dynamic BSS BW different from the first dynamic BSS BW;
configure a DSO setting for the second dynamic BSS BW based on a requirement that a future DSO sub-band for the DSO STA in the second dynamic BSS BW is to be renegotiated between the AP and the DSO STA unless a predefined criterion is met; and
transmit a Dynamic Bandwidth Expansion (DBE) announcement frame to announce the dynamic BSS BW change from the first dynamic BSS BW to the second dynamic BSS BW.

19. The product of claim 18, wherein the instructions, when executed, allow the AP to configure the future DSO sub-band for the DSO STA in the second dynamic BSS BW without a DSO renegotiation based on a determination that the current DSO sub-band is part of the second dynamic BSS BW.

20. The product of claim 18, wherein the instructions, when executed, allow the AP to configure the future DSO sub-band for the DSO STA to comprise a particular DSO sub-band in the second dynamic BSS BW without a DSO renegotiation based on a determination that there is no other possible sub-band for DSO in the second dynamic BSS BW.
